(19) United States
(12) Patent Application Publication
(10) Pub. No.: US 2026/0245021 A1
(43) Pub. Date: Aug. 20, 2026

(54) GENERATING ASSET MODELS

(71) Applicant: Honeywell International Inc., Charlotte, NC (US)

(72) Inventors: Rajesh Kulandaivel Sankarapandian, Cumming, GA (US); Veeranagegowda Shivalingappa, Hiriyuru (IN); Sumanth Pachipulusu Lingesh, Bengaluru (IN); Justin Thomas, Albuquerque, NM (US); Agniraj Chatterji, Kolkata (IN); R. Dhawan Kumar, Hyderabad (IN)

(21) Appl. No.: 19/055,950

(22) Filed: Feb. 18, 2025

(51) Int. Cl. G06Q 10/0637

(52) U.S. Cl. CPC G06Q 10/0637

(57) ABSTRACT

Devices, methods, and systems for generating asset models are described herein. A method can include receiving, by a processor of a computing device, a document that includes information about an asset, receiving a command, at a user interface of the computing device, to generate an asset model for the asset, and generating, by the processor in response to receiving the command, the asset model by scanning the received document for the information about the asset by searching keywords and phrases associated with attributes and metrics about the asset and populating the information about the asset from the received document into the asset model in response to finding at least one keyword or phrase.

### TECHNICAL FIELD

The present disclosure relates generally to devices, methods, and systems for generating asset models.

### BACKGROUND

To create a new asset model (e.g., domain model) a user collects information for a particular asset from various sources. Then the user manually enters that information into a system. This manual effort can be time-consuming. An asset can be equipment at an industrial site, for example.

### BRIEF DESCRIPTION OF THE DRAWINGS

FIG. 1 illustrates a block diagram of a computing device in accordance with an embodiment of the present disclosure.

FIG. 2 illustrates a block diagram of a computing device in accordance with an embodiment of the present disclosure.

FIG. 3 illustrates an example of a document and an asset model in accordance with an embodiment of the present disclosure.

FIG. 4 illustrates an example of a display on a user interface in accordance with an embodiment of the present disclosure.

FIG. 5 illustrates an example of a method for generating asset models in accordance with an embodiment of the present disclosure.

### DETAILED DESCRIPTION

Devices, methods, and systems for generating asset models are described herein. A method can include receiving, by a processor of a computing device, a document that includes information about an asset, receiving a command, at a user interface of the computing device, to generate an asset model for the asset, and generating, by the processor in response to receiving the command, the asset model by scanning the received document for the information about the asset by searching keywords and phrases associated with attributes and metrics about the asset and populating the information about the asset from the received document into the asset model in response to finding at least one keyword or phrase.

Currently, developing an asset model (e.g., a model of an asset of the domain) is a tedious process that requires a user to know a lot about the model. Typically, these models are templatized so that customers can instantiate and use them.

Further, customers can add their own model or extend an existing model. For example, as new assets are introduced to the market, new models will need to be created for those assets. However, to create a new asset model a user will have to collect as much information as possible for that particular asset from various sources and then manually enter that information into the system, which can be tedious and time consuming.

In contrast, the present disclosure can utilize generative artificial intelligence to generate new asset (e.g., domain) models, which can be less tedious and time consuming and therefore provide a better experience for the user. For example, documents that include information about an asset, such as, for instance, a centrifugal pump, can be fed into an onboarding portal. These documents can be from various sources, such as technical specification documents and websites, for instance.

Generative artificial intelligence (AI) can scan through the documents and websites for information specific to the asset, including asset properties, asset type, asset metric type, and asset metric and images, for example, that can be used to generate a model for the asset. Once all the information for the asset is collected, the information can be populated for the user to curate and create a new model.

As an example, a computing device can receive a document (e.g., technical specification website, etc.) that includes information about an asset, and a command to generate an asset model for the asset. In response to receiving the command, the computing device can generate the asset model for the asset by scanning the received document for information about the asset by searching for keywords and phrases associated with attributes and metrics about the asset and populating the information about the asset from the received document into the asset model in response to finding at least one keyword or phrase.

For instance, the computing device can populate the attributes and metrics about the asset (e.g., asset properties, asset type, asset metric type, and/or asset metric and images) from the received document into the asset model. In some embodiments, the computing device can determine the type of the asset based on the information about the asset from the received document, identify a parent asset of the asset based on the determined type of the asset, and populate inheritance metrics for the asset into the asset model based on the parent asset.

The present disclosure can be utilized in or in combination with an enterprise performance management software designed to optimize operations, improve efficiency, and enhance decision-making across various industries. The software can provide insights for users to take action on managing assets by integrating data analytics, artificial intelligence, and Internet of Things (IoT) technologies. For example, by compiling data from IoT devices and operational systems and monitoring performance, the software can predict maintenance needs, reduce energy consumption, and extend longevity of assets.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

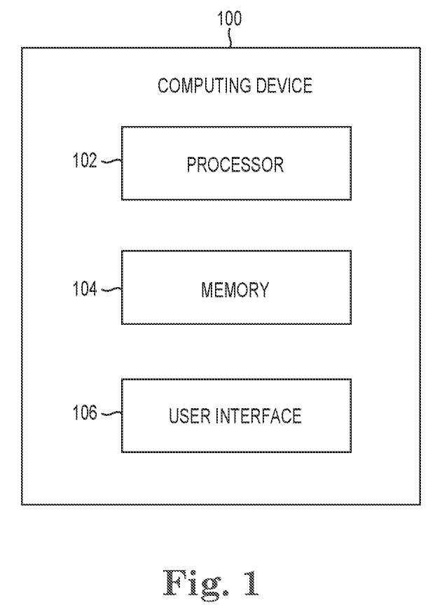

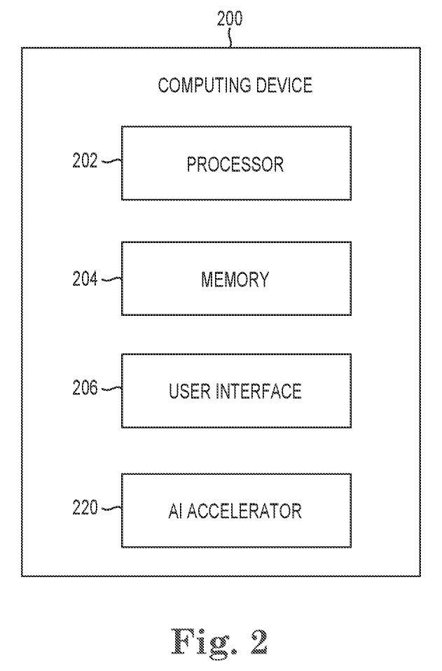

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

As used herein, “a”, “an”, or “a number of” something can refer to one or more such things, while “a plurality of” something can refer to more than one such things. For example, “a number of templates” can refer to one or more templates, while “a plurality of templates” can refer to more than one template.

FIG. 1 illustrates a block diagram of a computing device 100 in accordance with an embodiment of the present disclosure. In some examples, the computing device 100 can be a cloud computing device, a laptop computer, a desktop computer, or a mobile device, such as, for instance, a smart phone or a tablet, among other types of computing devices.

The computing device 100 can include or download a suite of cloud-based applications to enhance operational efficiency of assets (e.g., equipment and systems) of a facility (e.g., building). These applications can incorporate data from a number of assets (e.g., equipment) to provide insights and analytics to optimize performance of the number of assets, streamline operations, and support data-driven decision-making. For example, the computing device 100 can collect data from the number of assets of the building to monitor, maintain, and analyze the number of assets.

Each of the number of assets need to be onboarded in order for the computing device 100 to monitor, maintain, and analyze them. To create a new asset model a user collects information for a particular asset from various sources.

An asset can be a tank (e.g., a pressurized tank) in chemical manufacturing for oil, gas, and/or energy production, for instance. In a number of embodiments, a chemical manufacturing plant can use a pressurized tank to store and process volatile chemicals.

However, in order to create an asset model to onboard the asset, traditionally, a user would have to manually enter information about the asset into the computing device 100. For example, a user would have to search through specification sheets, technical documents, and/or websites to find and populate the information about the pressurized tank to create an asset model for the pressurized tank.

As an example, an oil refinery could have tens to hundreds of tanks used to store liquefied petroleum gas (LPG), liquified natural gas (LNG), hydrogen, nitrogen, or other gases used in the refining process. Each of the tens to hundreds of tanks at the refinery would need a user to find and populate information about it to create an asset model for each tank.

Embodiments of the present disclosure can reduce the time and effort burden on the user to improve productivity by automatically generating an asset model, as described herein. Further, lessening reliance on manual effort may reduce chances of human error thereby improving the quality of asset models.

The computing device 100 can include a processor 102, a memory 104, and a user interface 106. Memory 104 can be any type of storage medium that can be accessed by processor 102 to perform various examples of the present disclosure. For example, memory 104 can be a non-transitory computer readable medium having non-transitory machine-readable instructions (e.g., computer program instructions) stored thereon that are executable by processor 102 to perform various examples of the present disclosure.

For instance, processor 102 can execute the executable instructions stored in memory 104 to receive a document that includes information about an asset, receive, at the user interface 106, a command to generate an asset model for the asset, and generate, in response to receiving the command, the asset model by scanning the received document for the information about the asset by searching for keywords and phrases associated with attributes and metrics about the asset and populating the information about the asset from the received document into the asset model in response to finding at least one keyword or phrase.

A user onboarding the asset, for example, the pressurized tank for chemical manufacturing, can upload the document including the information about the pressurized tank. The document can be a specification document or a technical document of the pressurized tank, for example.

The processor 102 can populate the asset model with the type, manufacturer, model, serial number, capacity, stored material, and/or operating pressure of the pressurized tank from the document. For example, an asset model of the pressurized tank can include “floating roof storage tank” as the type, “API Standard 650 Tank” as the manufacturer, “AP-650 500,000 BBL Tank” as the model, “API650-2024-005” as the serial number, “500,000 barrels” as the capacity, “crude oil” as the stored material, and “.5 pounds per square inch” as the operating pressure.

Once the asset model is created and sensor data of the pressurized tank is being received at the application, the application can track tank level and volume, pressure fluctuations, temperature, vapor emissions, corrosion rates, and leaks. The application can set alarms for abnormal pressure and leaks and predict corrosion over time to plan maintenance. This can reduce costs, improve efficiency, ensure compliance of environmental and safety regulations, and reduce downtime of the pressurized tank.

In some examples, the processor 102 can receive a website address that includes the information about the asset in combination with the document or instead of the document. A website associated with the website address can be scanned to generate the asset model.

The memory 104 can store historical data and the asset model once generated. Historical data can include completed asset models and asset information. In some examples, the historical data can be limited to a specific asset and/or a specific industry. The historical data can be used to derive keywords and phrases associated with attributes and metrics to be used when searching the document of the asset.

Once the received document is scanned for the information about the asset, the processor 102 can populate the information about the asset into the asset model by populating the attributes and metrics about the asset into the asset model. The attributes and metrics about the asset can include at least one of asset properties, asset type, asset metric type, and asset metric and images, for example.

Further, the processor 102 can execute the executable instructions stored in memory 104 to display, at the user interface 106, the information about the asset from the received document in the asset model. The user interface 106 can be a graphic user interface (GUI) that can provide (e.g., display and/or present) and/or receive information to and/or from (e.g., input by) a user. User interface 106 can be, for example, a touch-screen (e.g., the GUI can include touch-screen capabilities).

The user interface 106 can be localized to any language. For example, the user interface 106 can display information in any language, such as English, Spanish, German, French, Mandarin, Arabic, Japanese, Hindi, etc.

The user interface 106 can receive a create command to create the asset model. In some examples, a selection of a parent template can be received at the user interface 106. The selection of the parent template can be from a drop-down menu including a number of templates. In some examples, the number of templates can be previously used templates.

The parent template can be employed to generate the asset template. For example, keywords and phrases can be identified in the parent template and searched in the received document to generate the asset model.

The user interface 106 can display a number of input fields. A first input field can be configured to receive an input as a file, for example, a document, a video, or an image. A second input field can be configured to receive an input as a website address. In some examples, the user interface can display the input field in response to receiving a selection of an auto generate button.

In a number of embodiments, the user interface 106 can receive a modification command to modify the asset model. This enables the user to manually add to or change portions of the asset model. For example, if the received document does not include all information needed to complete the asset model, a user can manually complete the asset model by entering the missing portions.

In some examples, the processor 102 can determine a type of the asset. The processor 102 can determine the type of the asset based on the information about the asset from the received document and/or website associated with the website address. Based on the determined type, the processor 102 can identify a parent asset of the asset.

Assets can be organized in a hierarchical order to exhibit the relationships and dependencies of the assets within an environment. A parent asset is an entity that includes one or more child assets. The hierarchical order of grouping related assets together enables easier monitoring and analysis of systems.

For example, in a chemical processing plant, a distillation unit could be a parent asset. A user could monitor the overall function of the distillation unit. Child assets of the distillation unit could include a distillation column, a reboiler, a condenser, and/or a pump. The user could further drill down from the parent asset to monitor the performance of each of the child assets.

Once a parent asset is identified, the processor 102 can populate inheritance metrics for the asset into the asset model based on the parent asset. In a hierarchical order, inheritance metrics can be a propagation of metrics from a parent asset to a child asset. For example, a child asset can be populated with the same performance metric as the parent asset. Automatically populating inheritance metrics can ensure uniform application of inheritance metrics across parent and child assets. Further, automatically populating inheritance metrics can be more efficient than a user manually entering the inheritance metrics.

In some examples, computing device 100 can receive documents and/or website addresses via a wired or wireless network (not shown in FIG. 1 for simplicity and so as not to obscure embodiments of the present disclosure). The network can be a network relationship through which the computing device 100 can communicate with other computing devices. Examples of such a network relationship can include a distributed computing environment (e.g., a cloud computing environment), a wide area network (WAN) such as the Internet, a local area network (LAN), a personal area network (PAN), a campus area network (CAN), or metropolitan area network (MAN), among other types of network relationships.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices together to form a distributed control network (e.g., cloud).

A network may provide connections to the Internet and/or to the networks of other entities (e.g., organizations, institutions, etc.). Users may interact with network-enabled software applications to make a network request, such as to get a file or sensor data from a sensor of an asset. Applications may also communicate with network management software, which can interact with network hardware to transmit information between devices on the network.

FIG. 2 illustrates a block diagram of a computing device 200 in accordance with an embodiment of the present disclosure. Computing device 200 can correspond to computing device 100 of FIG. 1. Computing device 200 can include a processor 202, a memory 204, a user interface 206, and an artificial intelligence (AI) accelerator 220. The processor 202, the memory 204, and the user interface 206 can correspond to processor 102, memory 104, and user interface 106 of FIG. 1, respectively.

The artificial intelligence accelerator 220 can include components including hardware, software, and/or firmware that enable the artificial intelligence accelerator 220 to perform artificial intelligence operations. The hardware can include an adder/multiplier to perform logic operations associated with artificial intelligence operations.

AI operations may include machine learning or neural network operations, which may include training operations or inference operations, or both. In some examples, memory 204 may represent a number of layers within a neural network or deep neural network (e.g., a network having three or more hidden layers). In some examples, memory 204 may be or include nodes of a neural network, and a layer of the neural network may be composed of multiple memory devices or portions of several memory devices. Memory 204 may store an artificial intelligence model, weights, inputs, outputs, and/or bias information of a neural network used by the artificial intelligence accelerator 220 to perform artificial intelligence operations.

The artificial intelligence accelerator 220 can receive commands to perform artificial intelligence operations. For example, the artificial intelligence accelerator 220 can receive a command from a host and/or the processor 202. The artificial intelligence operation can be performed in response to the command and results of the artificial intelligence operation can be reported to the host and/or processor 202 and/or stored in memory 204.

For instance, processor 202 can execute the executable instructions stored in memory 204 to receive a document that includes information about an asset, receive, at the user interface 206, a command to generate an asset model for the asset, and generate, in response to receiving the command, the asset model at the artificial intelligence accelerator 220 using artificial intelligence by scanning the received document for the information about the asset by searching for keywords and phrases associated with attributes and metrics about the asset and populating the information about the asset from the received document into the asset model in response to finding at least one keyword or phrase.

The asset can be an industrial steam boiler, for example. In such an example, a user at a food processing plant can be onboarding the industrial steam boiler into an application to monitor performance, optimize efficiency, and implement predictive maintenance of the industrial steam boiler.

In some examples, the artificial intelligence accelerator 220 can receive a website address that includes the information about the asset in combination with the document or instead of the document. A website associated with the website address can be scanned to generate the asset model.

The user can upload the document and/or provide the website address to be scanned by the artificial intelligence accelerator 220. The artificial intelligence accelerator 220 can populate the asset model with the name, manufacturer, model, serial number, fuel type, operating pressure, and/or steam output of the industrial steam boiler. For example, the generated asset model of the steam boiler can include “Industrial Fire-Tube Boiler” as the asset name, “Cleaver-Brooks” as the manufacturer, “CBLE-200-600-150ST” as the model, “CBX-987654” as the serial number, “Natural Gas” as the fuel type, “150 pounds per square inch” as the operating pressure, and “10,000 pounds per hour” as the steam output.

The asset model including the populated information about the steam boiler can be displayed on the user interface 206. The user interface 206 can be a GUI that can provide and/or receive information to and/or from the user. User interface 206 can be, for example, a touch-screen. The user interface 206 can be localized to any language. For example, the user interface 206 can display information in any language, such as English, Spanish, German, French, Mandarin, Arabic, Japanese, Hindi, etc.

Once the asset model is created and sensor data of the industrial steam boiler is being received at the application, the application can track steam pressure fluctuations, fuel consumption rates, temperature deviations, and/or burner efficiency and emissions. The application can compare the fuel efficiency against industry standards, create alerts for excessive fuel consumption, and predict degradation to optimize fuel-to-steam conversion and/or prevent unexpected failures.

The memory 204 can store historical data and the asset model once generated. Historical data can include completed asset models and asset information. In some examples, the historical data can be limited to a specific asset and/or a specific industry. The historical data can be used to derive keywords and phrases associated with attributes and metrics to be used when searching the document of the asset.

Once the received document is scanned for the information about the asset, the artificial intelligence accelerator 220 can populate the information about the asset into the asset model by populating the attributes and metrics about the asset into the asset model. The attributes and metrics about the asset can include at least one of asset properties, asset type, asset metric type, and asset metric and images, for example.

In some examples, the artificial intelligence accelerator 220 can determine a type of the asset. The artificial intelligence accelerator 220 can determine the type of the asset based on the information about the asset from the received document and/or website associated with the website address. Based on the determined type, the artificial intelligence accelerator 220 can identify a parent asset of the asset.

Assets can be organized in a hierarchical order to exhibit the relationships and dependencies of the assets within an environment. A parent asset is an entity that includes one or more child assets. The hierarchical order of grouping related assets together enables easier monitoring and analysis of systems.

For example, in a power plant, a gas turbine generator could be a parent asset. A user could monitor the overall function of the gas turbine generator. Child assets of the gas turbine generator could include a combustion chamber, a turbine blade, a generator unit, a cooling system, and/or a lubrication system. The user could further drill down from the parent asset to monitor the performance of each of the child assets.

Once a parent is identified, the artificial intelligence accelerator 220 can populate inheritance metrics for the asset into the asset model based on the parent asset. In a hierarchical order, inheritance metrics can be a propagation of metrics from a parent asset to a child asset. For example, a child asset can be populated with the same alarm metric as the parent asset. Automatically populating inheritance metrics can ensure uniform application of inheritance metrics across parent and child assets. Further, automatically populating inheritance metrics can be more efficient than a user manually entering the inheritance metrics.

In some examples, computing device 200 can receive documents and/or website addresses via a wired or wireless network. The network can be a network relationship through which the computing device 200 can communicate with other computing devices. Examples of such a network relationship can include a distributed computing environment, a WAN, a LAN, a PAN, a CAN, or a MAN, among other types of network relationships.

The network can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices together to form a distributed control network.

A network may provide connections to the Internet and/or to the networks of other entities. Users may interact with network-enabled software applications to make a network request, such as to get a file or sensor data from a sensor of an asset. Applications may also communicate with network management software, which can interact with network hardware to transmit information between devices on the network.

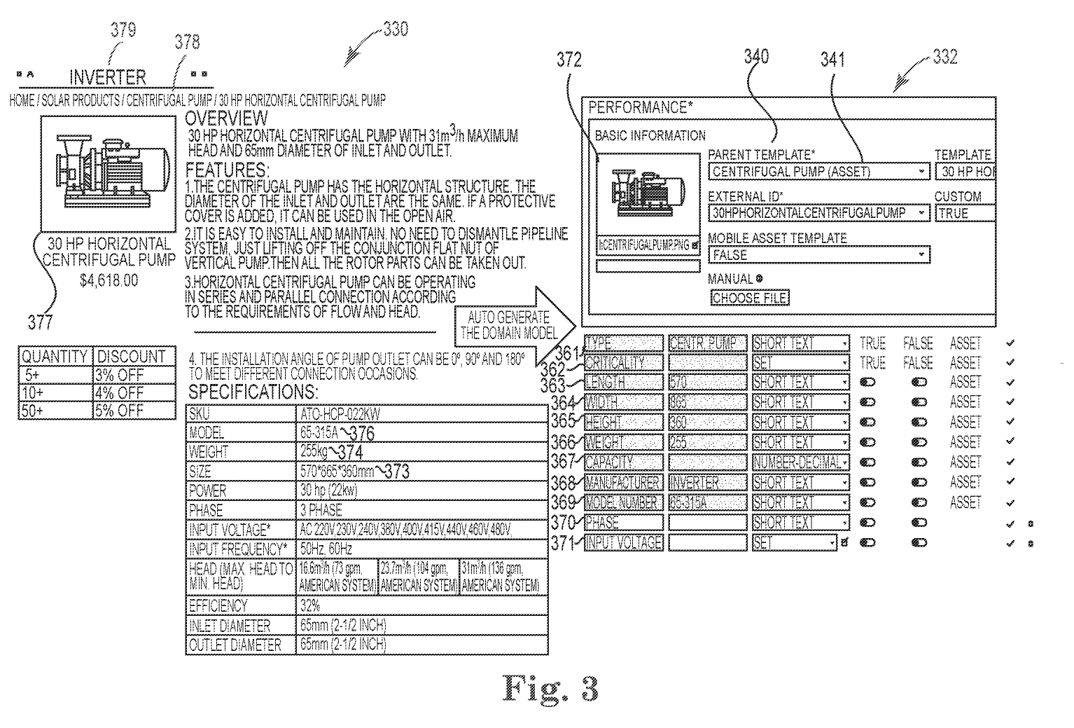

FIG. 3 illustrates an example of a website 330 and an asset model 332 in accordance with an embodiment of the present disclosure. The website 330 can be associated with a website address that includes information about an asset. In the example illustrated in FIG. 3, the asset can be a horizontal centrifugal pump and a website address can be inverter.com. However, embodiments are not limited to this example.

In the example illustrated in FIG. 3, the website 330 includes an overview of the horizontal centrifugal pump. For example, the overview indicates, “30HP horizontal centrifugal pump with 31m³/h maximum head and 65mm diameter of inlet and outlet.”

Further, in the example illustrated in FIG. 3, the website 330 includes features of the horizontal centrifugal pump. For example, the features include the centrifugal pump has the horizontal structure. The diameter of the inlet and outlet are the same. If a protective cover is added, it can be used in the open air. It is easy to install and maintain. No need to dismantle pipeline system, just lifting off the conjunction flat nut of vertical pump. Then all the rotor parts can be taken out. Horizontal centrifugal pump can be operating in series and parallel connection according to the requirements of flow and head. The installation angle of pump outlet can be 0°, 90°, and 180° to meet different connection occasions.

Further, in the example illustrated in FIG. 3, the website 330 includes specification of the horizontal centrifugal pump. For example, the specifications include a SKU of ATO-HCP-022KW, model 65-315A, a weight of 255kg, a size of 570*865*360*mm, power of 30 hp (22kw), a 3 phase, an input voltage of AC 220V, 230V, 240V, 380V, 400V, 415V, 440V, 460V, 480V, an input frequency of 50Hz, 60Hz, a head of 16.6m³/h (73 gpm, American system), 23.7m³/h (104 gpm, American system), 31m³/h (136 gpm, American system), efficiency of 32%, an inlet diameter of 65 mm (2-1/2 inch), and an outlet diameter of 65mm (2-1/2 inch).

Further, in the example illustrated in FIG. 3, the website 330 includes the cost and quantity based on discounts of the horizontal centrifugal pump. For example, at a quantity of 5+, the discount is 3%. With a quantity of 10+, the discount is 4% and with a quantity of 50+, the discount is 5%.

In some examples, a processor (e.g., processor 102 and 202 of FIGS. 1 and 2, respectively) can receive the website address that includes the information about the asset and/or a document that includes the information about the asset. The website 330 associated with the website address and/or the document can be scanned to generate the asset model 332.

The asset model 332 can be generated by scanning the website 330 and/or the document for the information about the asset by searching for keywords and phrases associated with attributes and metrics about the asset. Further, the asset model 332 can be generated by populating the information about the asset from the website 330 and/or the received document into the asset model 332 in response to finding at least one keyword or phrase.

The user may create an asset model 332 and select a parent template 340. For example, a user interface (e.g., user interface 106 and 206 of FIGS. 1 and 2, respectively) can receive a create command to create the asset model 332 and a selection of the parent template 340. The selection of the parent template 340 can be from a drop-down menu 341 including a number of templates. In the example illustrated in FIG. 3, the parent template is “centrifugal pump (asset)”. In some examples, the number of templates can be previously used templates.

The parent template 340 can be employed to generate the asset model 332. For example, the keywords and phrases can be identified in the parent template 340 and searched on the website 330 to generate the asset model 332.

In the example illustrated in FIG. 3, the processor can identify type 361, criticality 362, length 363, width 364, height 365, weight 366, capacity 367, manufacturer 368, model number 369, phase 370, and input voltage 371 as keywords to search for on the website 330. Synonyms of the keywords can also be searched on the website. For example, the processor can search for size as a synonym for length, width, and height. Further, the processor could search for units associated with a keyword. The processor could scan the website for the use of pounds, lbs., kilograms, or Kg to identify the weight 366 of the asset, for instance.

A “centrifugal pump” can be identified as the type 361 of the asset from information 378 from the website 330. The processor can determine the length 363 is 570 millimeters, the width 364 is 865 millimeters, and the height 365 is 360 millimeters from information 373 from the website 330. The weight 366 can be determined to be 255 kilograms from information 374 from the website 330. The processor can determine the manufacturer 368 is “Inverter” from information 379 of the website 330. The model number 369 can be determined to be “65-315A” from information 376 of the website 330. The processor can further populate an image 372 of the asset from image 377 of the website 330, as illustrated in FIG. 3.

The populated information about the asset can be defined as an attribute type. For example, an attribute type can be a short text, set, or a number-decimal. The short text can be brief textual information about the asset for asset names or model numbers, for instance. The set can be a value selected from a list of options for status indicators or classifications, for example. The number-decimal can be numerical data that may include decimal points for dimensions or capacities, for instance.

Further the asset model 332 can include true and false toggles. The true and false toggles can correspond to a Boolean attribute of an asset to select states or conditions of an asset where the only possible values are true or false.

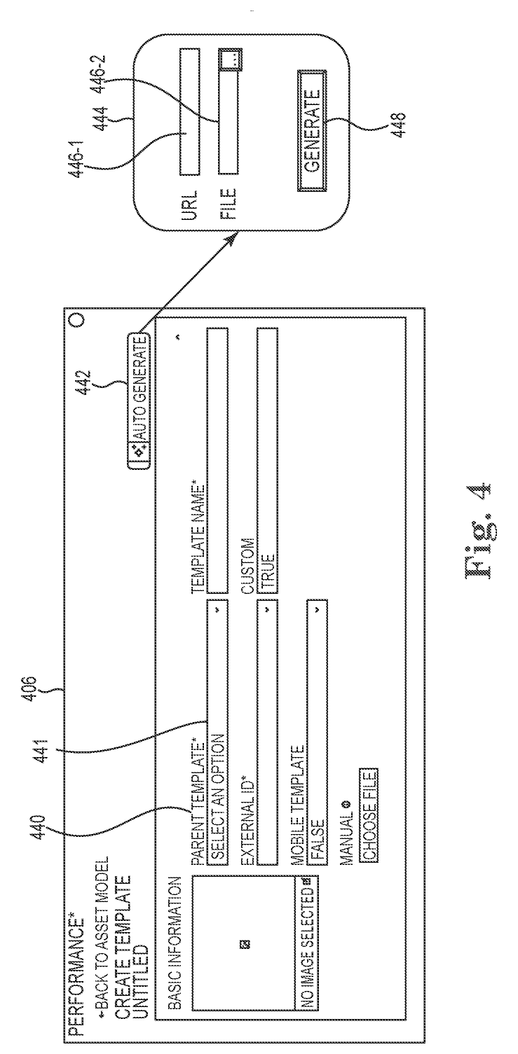

FIG. 4 illustrates an example of a display on a user interface 406 in accordance with an embodiment of the present disclosure. User interface 406 can correspond to user interface 106 and 206 of FIGS. 1 and 2, respectively.

The user interface 406 can be a graphic user interface that can provide and/or receive information to and/or from a user. For example, the user interface 406 can receive a create command to create an asset model (e.g., asset model 332 of FIG. 3).

In some examples, a selection of a parent template 440 can be received at the user interface 406. Parent template 440 can correspond to parent template 340 of FIG. 3. The selection of the parent template 440 can be from a drop-down menu 441 including a number of templates. Drop-down menu 441 can correspond to drop-down menu 341 of FIG. 3. In some examples, the number of templates can be previously used templates from different assets.

The parent template 440 can be employed to generate the asset model. For example, keywords and phrases can be identified in the parent template and searched in the received document to generate the asset model.

The user interface 406 can display a number of input fields 446-1 and 446-2. A first input field 446-1 can be configured to receive an input as a website address (e.g., a URL). A second input field 446-2 can be configured to receive an input as a file, for example, a document, a video, or an image. In some examples, the user interface 406 can display the number of input fields 446-1 and 446-2 in a pop-up box 444 in response to receiving a selection of an auto generate button 442.

As an example, a user can input a website address into the first input field 446-1 that is associated with a website that includes information about a crude distillation column. The user can further input a document into the second input field 446-2 that also includes information about the crude distillation column. From the website and the document, a processor (e.g., processor 102 and 202 of FIGS. 1 and 2, respectively) can identify a type, manufacturer, model, serial number, operating pressure, operating temperature, feedstock, and/or products of the distillation column. For example, an asset model of the distillation column, once populated by the processor in response to a user selecting a generate button 448, can include “Fractionating Column” as the type, “Koch-Glitsch” as the manufacturer, “KG-FD-300” as the model, “KGDC-2024-002” as the serial number, “150,000 barrels per day” as the capacity, “2.5 atmospheres to 4.5 atmospheres” as the operating pressure, “120 degrees Celsius to 380 degrees Celsius” as the operating temperature, and “Gasoline, Kerosene, Diesel, Residue” as the products of the distillation column.

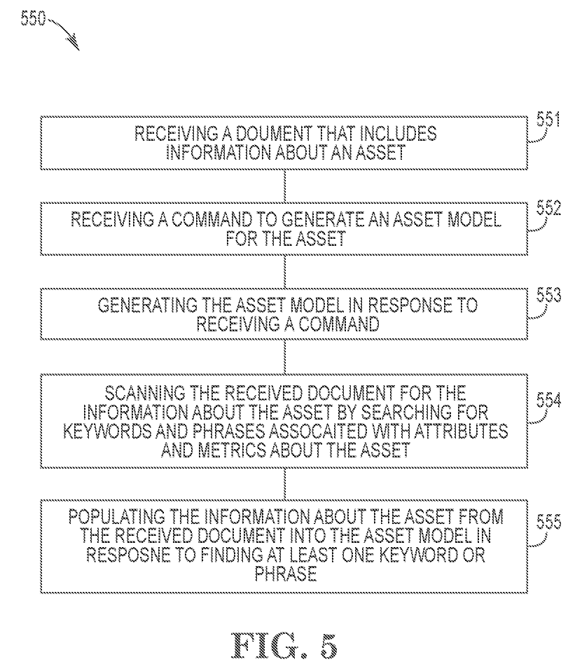

FIG. 5 illustrates an example of a method 550 for generating asset models in accordance with an embodiment of the present disclosure. Method 550 can be performed by, for example, computing device 100 and/or 200 described in connection with FIGS. 1 and 2.

At block 551, method 550 includes receiving a document that includes information about an asset. The document can be a specification sheet, a technical document, or an image. In some examples, a website address can be received instead of or in addition to the document. A website associated with the website address can include information about the asset.

At block 552, method 550 includes receiving a command to generate an asset model (e.g., asset model 332 of FIG. 3) for the asset. The asset can be an equipment or system of a facility. For example, the asset can be a heating, ventilation, air conditioning (HVAC) system or other energy-consuming equipment. The asset can be located in a commercial building, for instance, an office complex or a hospital.

A generate button can be displayed on a user interface (e.g., user interface 106, 206, and 406 of FIGS. 1, 2, and 4, respectively). The user interface can be a graphic user interface that can provide and/or receive information to and/or from a user. For example, the user interface can receive a selection of the generate button from the user.

At block 553, method 550 includes generating the asset model in response to receiving a command. Generating the asset model can be part of onboarding the asset to use in an application. The application can provide insights and analytics to optimize performance of the asset, streamline operations, and support data-driven decision-making. For example, the application can collect data from the asset to monitor, maintain, and analyze the asset.

At block 554, method 550 includes scanning the received document for the information about the asset by searching for keywords and phrases associated with attributes and metrics about the asset. Historical data can be used to derive the keywords and the phrases associated with the attributes and the metrics to be used when searching the document of the asset. The historical data can include completed asset models and asset information.

In a number of embodiments, a parent template can assist in scanning the received document. For example, the keywords and the phrases can be identified in the parent template and searched in the received document to generate the asset model.

At block 555, method 550 includes populating the information about the asset from the received document into the asset model in response to finding at least one keyword or phrase. Populating the information about the asset into the asset model can include populating the attributes and metrics about the asset into the asset model.

In a number of embodiments, method 550 can be performed using artificial intelligence operations by, for example, an artificial accelerator (e.g., artificial intelligence accelerator 220 of FIG. 2). The method 550 can further include the artificial intelligence accelerator receiving a command to perform artificial intelligence operations and performing the artificial intelligence operations to generate the asset model. The command to perform the artificial intelligence operations can be from the processor or a host.

The attributes and metrics about the asset can include asset properties, asset type, asset metric type, and asset metric and images, for example. Further an image of the asset can be populated from the received document.

In some examples, the method 550 can include displaying, at the user interface, the information about the asset from the received document in the asset model. The attributes and metrics about the asset can be displayed, for instance.

In a number of embodiments, the method 550 can include determining a type of the asset. The type of the asset can be based on the information about the asset from the received document. For example, the type of asset can be a tank.

The method 550 can further include identifying a parent asset of the asset based on the determined type of the asset. Inheritance metrics for the asset can be populated into the asset model based on the parent asset.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving, by a processor of a computing device, a document that includes information about an asset;
receiving a command, at a user interface of the computing device, to generate an asset model for the asset; and
generating, by the processor in response to receiving the command, the asset model by:
scanning the received document for the information about the asset by searching for keywords and phrases associated with attributes and metrics about the asset; and
populating the information about the asset from the received document into the asset model in response to finding at least one keyword or phrase.

2. The method of claim 1, wherein populating the information about the asset into the asset model comprises populating the attributes and metrics about the asset into the asset model.

3. The method of claim 1, wherein the attributes and metrics about the asset include at least one of: asset properties, asset type, asset metric type, and asset metric and images.

4. The method of claim 1, further comprising displaying, at the user interface, the information about the asset from the received document in the asset model.

5. The method of claim 1, further comprising determining, by the processor, a type of the asset based on the information about the asset from the received document.

6. The method of claim 5, further comprising identifying, by the processor, a parent asset of the asset based on the determined type of the asset.

7. The method of claim 6, further comprising populating, by the processor, inheritance metrics for the asset into the asset model based on the parent asset.

8. A computing device, comprising:
a user interface;
a processor; and
a memory storing non-transitory machine-readable instructions to cause the processor to:
receive a document that includes information about an asset;
receive, at the user interface, a command to generate an asset model for the asset;
generate, in response to receiving the command, the asset model by:
scanning the received document for the information about the asset by searching for keywords and phrases associated with attributes and metrics about the asset; and
populating the information about the asset from the received document into the asset model in response to finding at least one keyword or phrase; and
display, at the user interface, the asset model.

9. The computing device of claim 8, wherein the user interface is configured to receive a command to modify the asset model.

10. The computing device of claim 8, wherein the user interface is configured to receive a command to create the asset model.

11. The computing device of claim 10, wherein the created asset model is stored in the memory.

12. The computing device of claim 10, wherein receiving the command to create the asset model includes receiving a selection of a parent template.

13. The computing device of claim 12, wherein the user interface is configured to receive the selection of the parent template from a drop-down menu including a number of templates previously used.

14. The computing device of claim 8, wherein the processor is configured to use artificial intelligence operations to generate the asset model.

15. The computing device of claim 8, wherein the processor is configured to receive a website address that includes the information about the asset.

16. A computing device, comprising:
a user interface;
a processor; and
a memory storing non-transitory machine-readable instructions to cause the processor to:
display, at the user interface, an input field;
receive, at the user interface, an input in the input field that
includes information about an asset;
receive, at the user interface, a command to generate an
asset model for the asset; and
generate, in response to receiving the command, the asset model by:
scanning the received input for the information about the asset by searching for keywords and phrases associated with attributes and metrics about the asset; and
populating the information about the asset from the received input into the asset model in response to finding at least one keyword or phrase.

17. The computing device of claim 16, wherein the user interface is configured to display a different input field.

18. The computing device of claim 17, wherein the input field is configured to receive a website address as the input and the different input field is configured to receive a file as a different input.

19. The computing device of claim 17, wherein the user interface is configured to display the input field and the different input field in response to receiving a selection of an auto generate button.

20. The computing device of claim 17, wherein the processor is configured to generate the asset model by scanning a website associated with the website address.
